(19) United States
(12) Patent Application Publication
(10) Pub. No.: US 2015/0254744 A1
(43) Pub. Date: Sep. 10, 2015

(54) METHOD OF ADMINISTERING A COMPETITIVE BID

(71) Applicant: Engineered Internet Solutions, Inc., Marthasville, MO (US)

(72) Inventors: Patrick Meyer, Marthasville, MO (US); Brad Pecka, Washington, MO (US)

(21) Appl. No.: 14/642,420

(22) Filed: Mar. 9, 2015

Related U.S. Application Data
(60) Provisional application No. 61/949,608, filed on Mar. 7, 2014.

(51) Int. Cl. G06Q 30/06; H04L 29/06

(52) U.S. Cl. CPC G06Q 30/0611; H04L 67/42

(57) ABSTRACT

A method of administering a bid, through a computer system having a one server, a client device, and a communication network operatively and electrically connecting the client device to the least one server. A first user accesses from the client device, a website running on the server, and enters data into the client device. A second user accesses from the client device, the website and enters data into the client device. The data is transmitted to the server. A program generates results on the server, and displays the results associated with the data on the client device. Bidding information is communicated between the first user and the second user through a bidding program.

### CROSS-REFERENCE TO RELATED APPLICATIONS

This Non-Provisional application claims priority to U.S. Provisional Application Ser. No. 61/949,608 filed Mar. 7, 2014, and which is incorporated herein by reference.

### STATEMENT REGARDING FEDERALLY SPONSORED RESEARCH

Not Applicable.

### BACKGROUND

The present invention relates to a system of administrating a competitive bidding process. More particularly, the present invention relates to an electronic system of administering a competitive bidding process over a network.

In many industries, the competitive bidding process is used to procure features and goods. This process is particularly used in government and construction contracts. Generally, during a competitive bidding process competing contractors, suppliers, or vendors submit bids for a contract according to a set of specification, criteria, and terms and conditions.

The intended benefits of the competitive bidding process are to stimulate competition to provide the best goods or features at the lowest prices. In addition, the process mitigates corruption and favoritism towards a single contractor, supplier, or vendor. There are numerous variations on this general process. For example, one variation is open bidding where sealed bids are opened in full view of witnesses, while closed bidding involves opening the sealed bids in the presence of only authorized personnel.

However, there are several disadvantages to the competitive bidding process. For instance, the timeframe to complete the process can be extremely long. In fact, it is not unusual for government agency contracts to take several years to choose a successful bidder. As a result, the customer can wait long periods of time for a product feature that may be required quickly. Furthermore, preparation of the bids can be time-consuming, complicated, and expensive in order to consider lengthy contracts with detailed specifications and requirements.

Therefore, what is needed a competitive bidding process that is more cost effective and streamlined.

### DESCRIPTION OF THE DRAWINGS

In the accompanying drawings which form part of the specification:

FIG. 1 is a block diagram of a system for administrating a competitive bid program in accordance with the present invention;

FIG. 2 is a sample home webpage appearing on the display of the client device;

FIG. 3 is a sample registration webpage appearing on the display of the client device;

FIG. 4 is a second sample registration webpage appearing on the display of the client device;

FIG. 5 is a third sample registration webpage appearing on the display of the client device;

FIG. 6 is a fourth sample registration webpage appearing on the display of the client device;

FIG. 7 is a sample post listing webpage appearing on the display of the client device;

FIG. 8 is a sample bidding client listings search results webpage appearing on the display of the client device;

FIG. 9 is a sample bidding client bid access request webpage appearing on the display of the client device;

FIG. 10 is a sample listing client listing details with access options webpage appearing on the display of the client device;

FIG. 11 is a sample bidding client full bid details and bid entry webpage appearing on the display of the client device;

FIG. 12 is a sample listing client summary of listings webpage with selection options appearing on the display of the client device;

FIG. 13 is a sample listing client listing details webpage with acceptance options appearing on the display of the client device;

FIG. 14 is a sample listing client message to bidding client webpage appearing on the display of the client device;

FIG. 15 is a sample bidding client profile webpage appearing on the display of the client device;

FIG. 16 is a sample listing updates webpage appearing on the display of the client device;

FIG. 17 is a sample bidding client profile webpage with notification option appearing on the display of the client device;

FIG. 18 is a sample listing client listing details webpage with a review option appearing on the display of the client device;

FIG. 19 is a sample review of bidding client webpage appearing on the display of the client device;

FIG. 20 is a sample bidding client summary of listings webpage with selection options appearing on the display of the client device;

FIG. 21 is a sample bidding client message to listing client webpage appearing on the display of the client device;

FIG. 22 is a sample listing client profile webpage appearing on the display of the client device;

FIG. 23 is a sample bid updates webpage appearing on the display of the client device;

FIG. 24 is a sample bidding client bid details webpage with a review option appearing on the display of the client device;

FIG. 25 is a sample review of listing client webpage appearing on the display of the client device;

FIG. 26 is a sample post advertisement webpage appearing on the display of the client device;

FIG. 27 is a sample collection of advertisements with selection options webpage appearing on the display of the client device;

FIG. 28 is a sample advertisement notification webpage appearing on the display of the client device;

FIG. 29 is a sample inbox webpage appearing on the display of the client device;

FIG. 30 is a sample message details webpage appearing on the display of the client device; and

FIG. 31 is a sample summary of bidders with selection options webpage appearing on the display of the client device; and

FIG. 32 is a sample-webpage appearing on the display of the client device.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

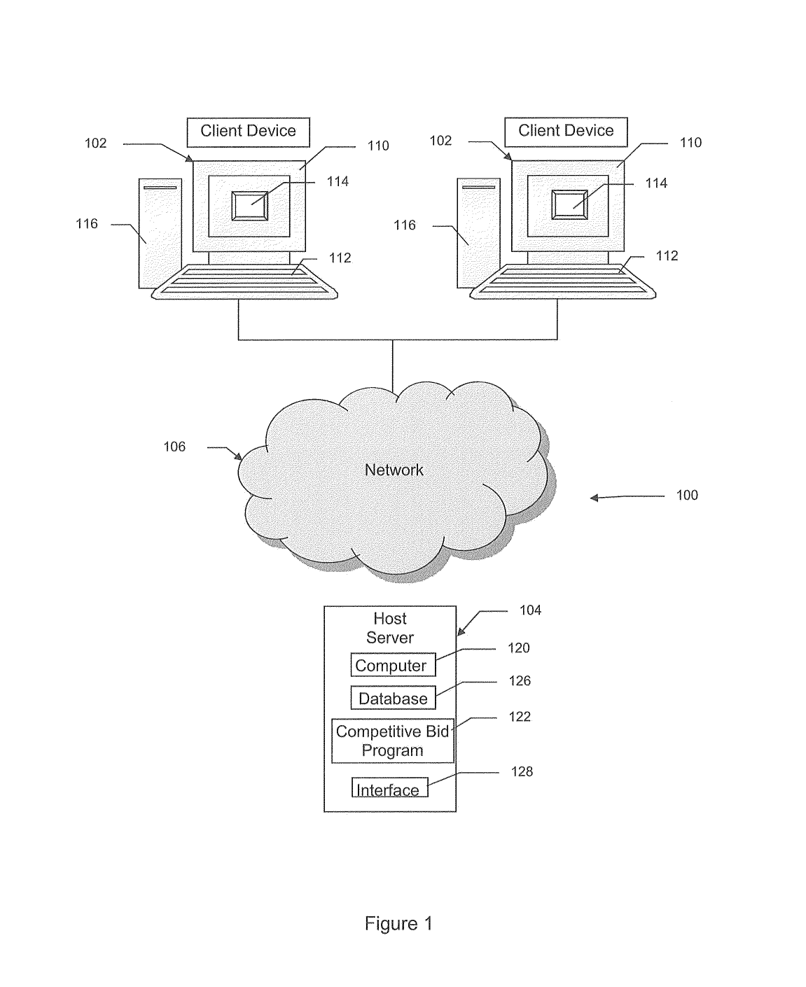

As shown in FIG. 1, an embodiment of the present invention, generally referred to as a method of administering a competitive bid process utilizes a computer system 100 with at least one client device 102 operatively connected to at least one host server 104 through a communication network 106 to communicate data between the client device 102 and the host server 104. The computer system 100 is capable of administering a competitive bid program 122, which is described below in further detail.

In the embodiment of FIG. 1, the client device 102 is a computer, including a processor, memory, a mass storage device, a display device 110, and an input device 112, such as a keyboard, that is capable of running a network interfacing program 114, such as web browser software available, for example, from Netscape® Corporation, Apple® Corporation, or from Microsoft® Corporation. The client device 102 is appropriately equipped with a network interfacing device 116 for communicating data with the network 106, such as a dial-up modem, a cable modem, a satellite connection, a DSL (Digital Subscriber Line) connection, a LAN (Local Area Network), or the like. Alternate embodiments of client device 102 include any electrical or electronic device capable of communicating with the server 104 through the network 106, such as, for example, a personal digital assistant (PDA), cellular phone, a telephone operating with an interactive voice-system, or a television operating with a cable or satellite television interactive system.

The client device 102 can be used for entry of data in a text, video, or audio format via the keyboard, or other suitable input interface such as a mouse, microphone, touch screen, scanner, and the like. The network interfacing program 114 allows the user to enter addresses of specific webpages to be retrieved, which are referred to as Uniform Resource Locators, or URLs. The webpages can contain various types of content from plain textual information to more complex multimedia and interactive content, such as software programs, graphics, audio signals, videos, and so forth. A set of interconnected webpages, usually including a homepage, are managed on a server device as a collection collectively referred to as a website. The content and operation of such websites are managed by the server device, such as host server 104, which is operatively connected to the network 106.

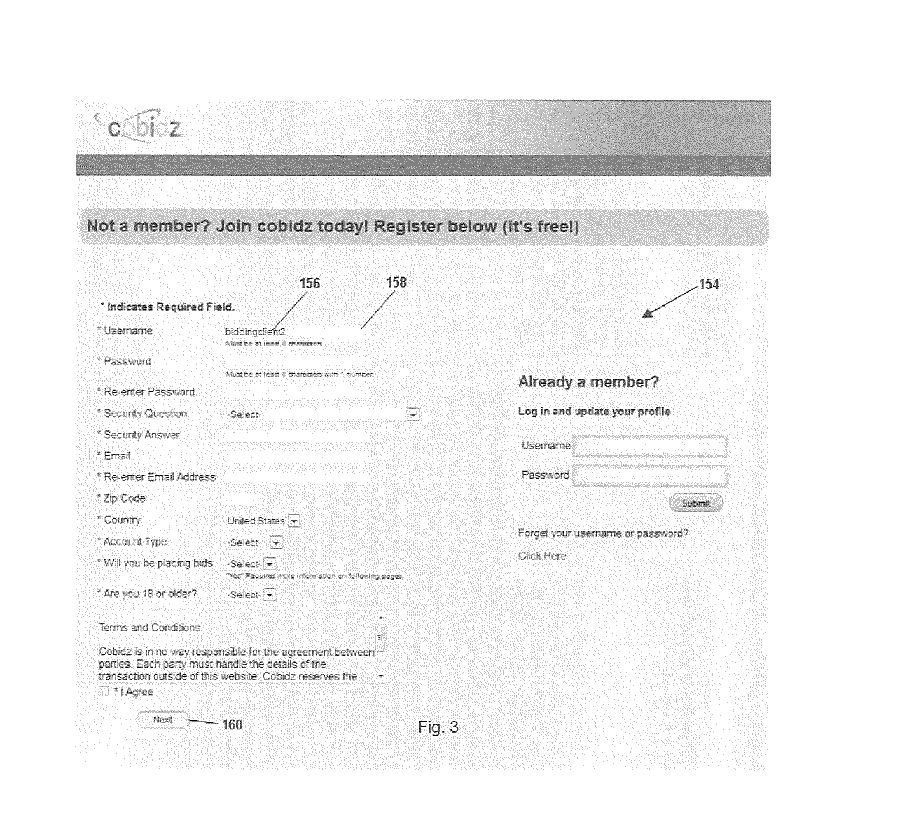

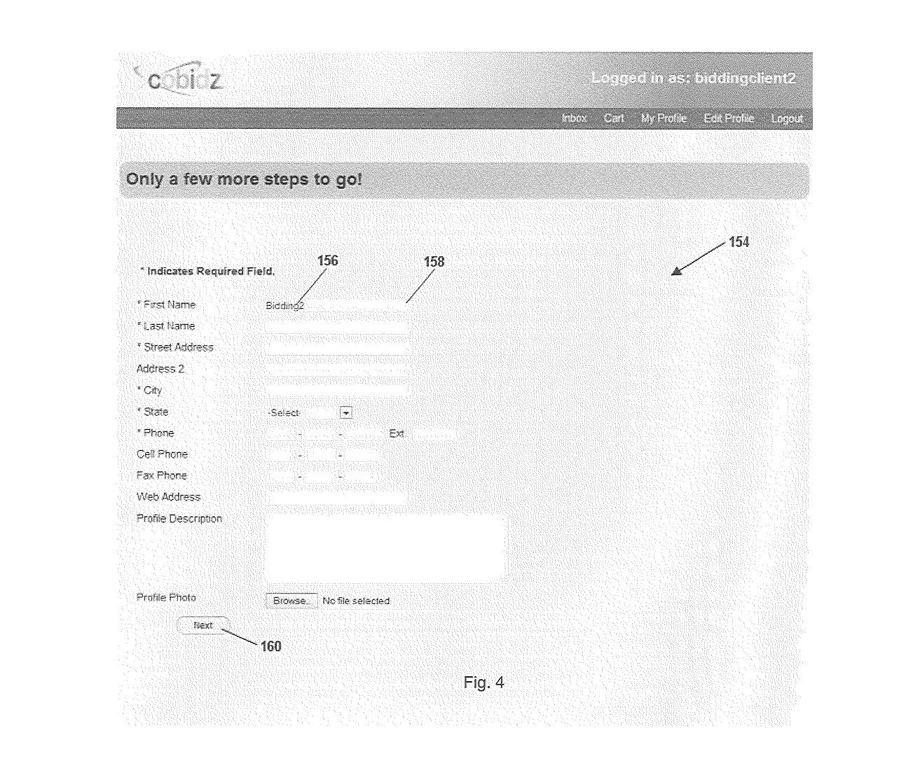

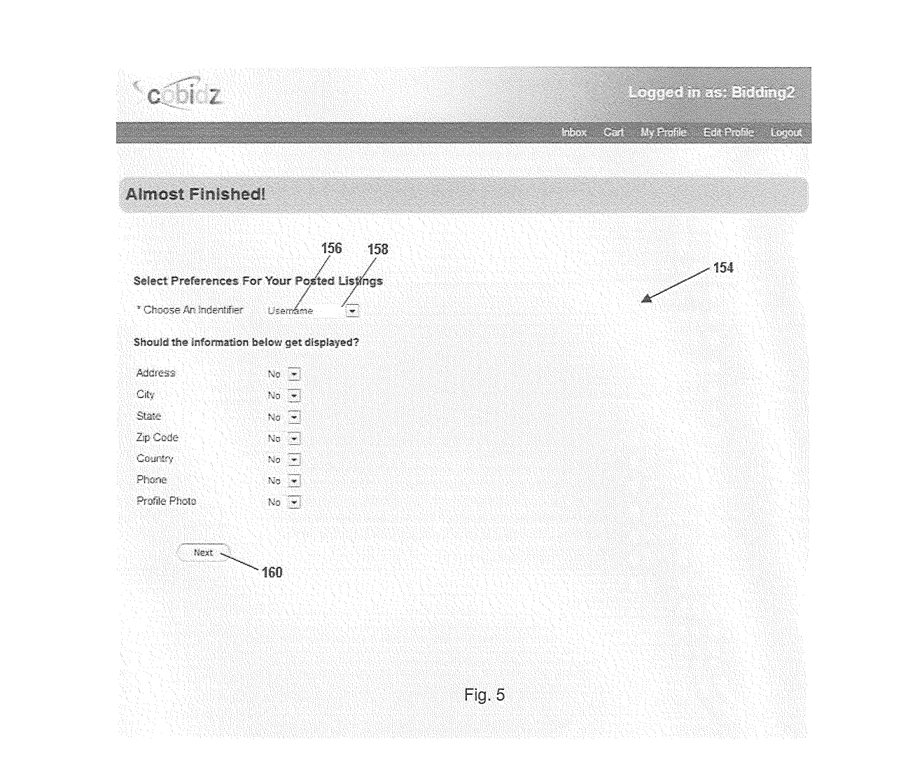

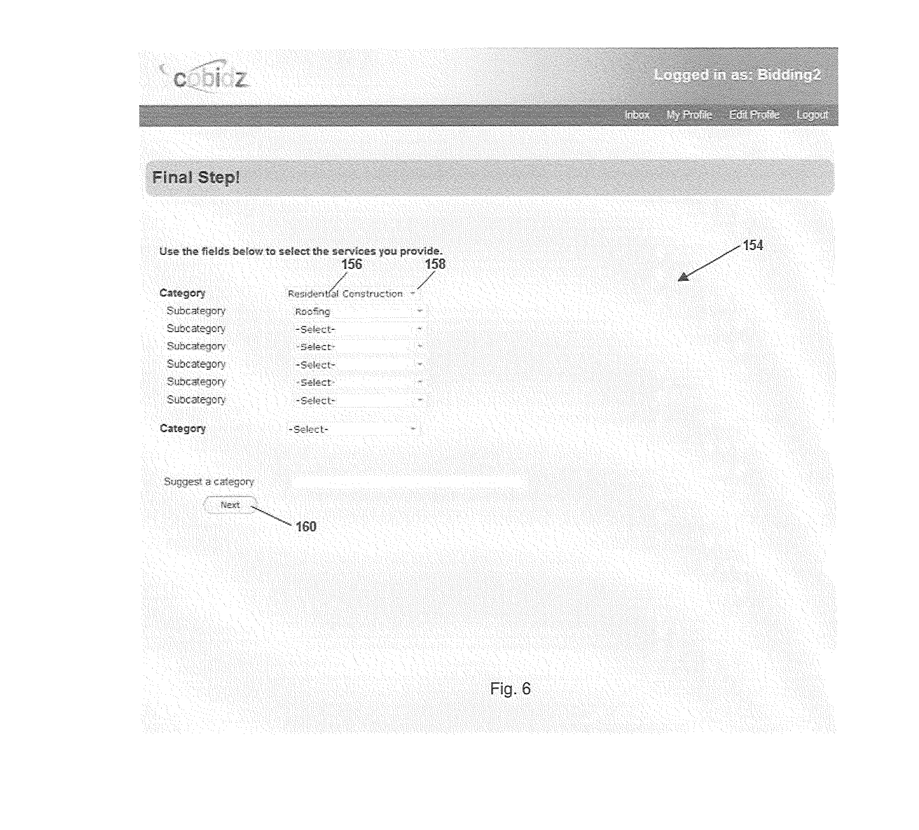

For example, the bid program 122 generates a webpage, such as registration page 154 (FIGS. 3-6), that transmits through the network 106 and displays on the display 110. In the preferred embodiment, the registration page 154 includes a plurality of data fields 158. The user interacts with the bid program 122 by entering data with the input device 112. By selecting one of these options, the bid program 122 generates additional webpages and interacts with the database 126 and the client device 102 in order to communicate data. The content and operation of such websites are managed by the server device, such as host server 104, which is operatively connected to the network 106.

In the embodiment of FIG. 1, the network 106 is the Internet, which uses a suitable communications protocol, such as HyperText Transfer Protocol (HTTP), to communicate data between the client devices 102 and the host server 104. However, the network 106 can be any network that allows an exchange of data between the client devices 102 and the host server 104, such as a LAN or WAN (Wide Area Network). In addition, any suitable type of communications protocol can be used, such as FTP (File Transfer Protocol), SNMP (Simple Network Management Protocol), TELNET (Telephone Network), and the like. Alternatively, the client device 102 can be directly connected to the host server 104 for communication of data.

The host server 104 preferably comprises a computer system 120, having a processor, memory, and a mass storage device, which is capable of running a bid program 122. A database 126 is stored on the mass storage device. Also, the host server 104 is appropriately equipped with a network interfacing device 128 for communicating data with the network 106, such as a dial-up modem, a cable modem, a satellite connection, a DSL connection, a LAN, or the like. If necessary to accommodate large amounts of information or run numerous applications, alternate embodiments of the host server 104 can comprise multiple computer systems, multiple databases, or any combination thereof.

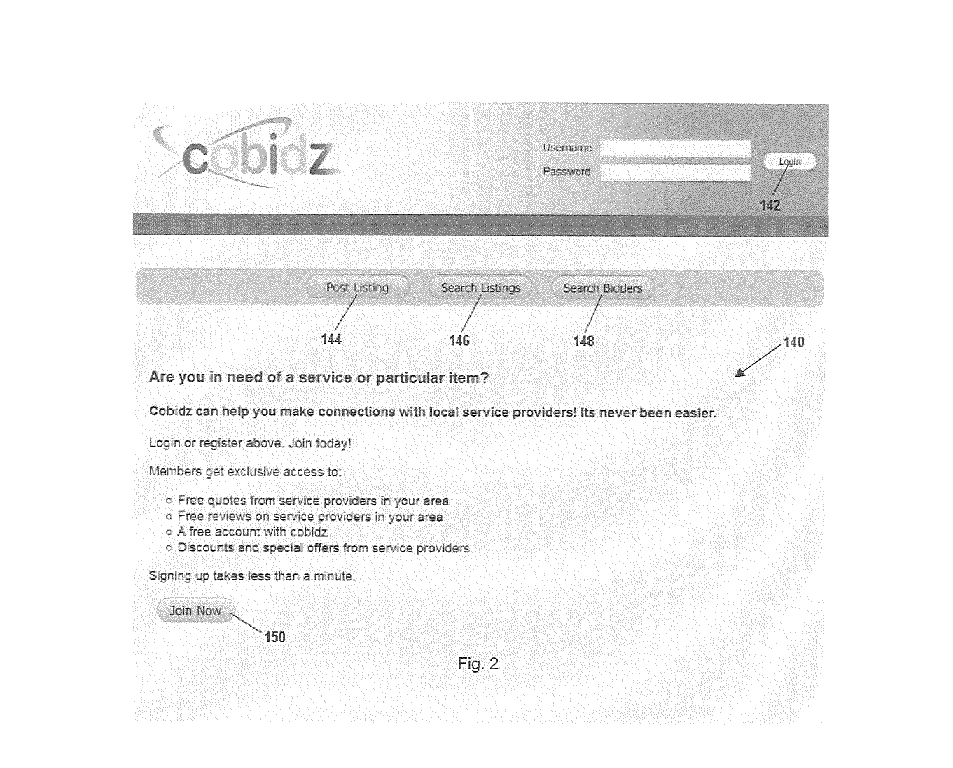

The bid program 122 allows users through the interfacing program 114 of the client device 102 to access various features of the bid program 122 on the host server 104. As shown in FIG. 2, the bid program 122 generates a webpage, such as home page 140, that transmits through the network 106 and displays on the client device display 110 via the interfacing program 114. In the preferred embodiment, the home page 140 includes a menu of the various options including Login 142, Post Listing 144, Search Listings 146, Search Bidders 148, and Join Now 150 (FIG. 2). The user interacts with the bid program 122 by entering data with the input device 112, in this case by selecting one of the options. By selecting one of these options, the bid program 122 generates additional webpages and interacts with the database 126 and the client device 102 in order to provide the selected features to the user.

The options shown in FIGS. 2-31 are exemplary only and not inclusive. Those skilled in the art will recognize the bid program 122 can provide access to any number of options and features, which may include, but are not limited to discussion forums, newsgroups, networking features, bulletin boards, chat room, retail and commercial sales, auctions, weblogs, email, video logging, database searches, and other web applications.

The operation of the system 100 begins with the step of registering users as users, such as listing clients and bidding clients. To register, a user utilizes the client device 102 to access the home page 140 and select Join Now 150 (FIG. 2), which displays the webpage registration forms 154 shown in FIGS. 3-6 to the user on the display 110 of the client device 102. Using the keyboard 112, the user enters registration data 156 into the fields 158 of the registration forms 154, which can include, but is not limited to a Username, a Password, an Email address, a profile picture, display options, bidding categories, and other personal information. After entering the registration data 156, the user presses the “Next” button 160 to electronically transfer the registration data 156 through the network 106 to the host server 104. The registration data 156 is recorded in a master account on the database 126, so that the host server can identify the user as a listing client or a bidding client or both.

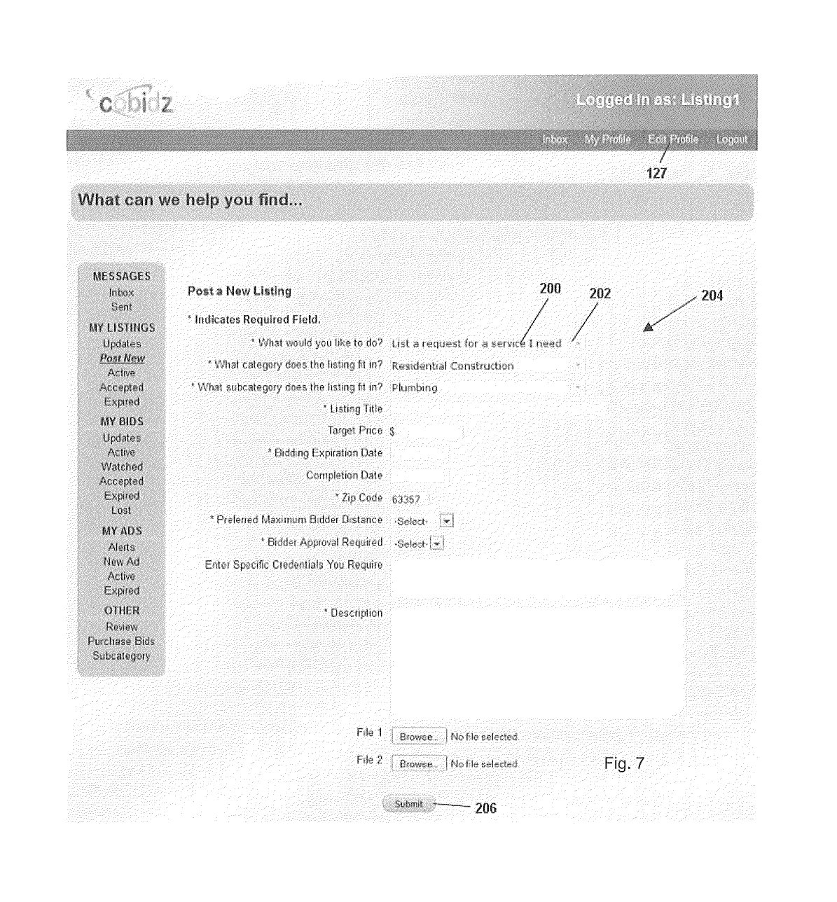

To review and/or modify any registration data 156 the user may select Edit Profile 127 (FIG. 7), and make any necessary changes. Each time the user accesses the host server 104 through the client device 102, the bid program 122 confirms that the user is a registered user. This can be done by a manual or automatic login procedure, which requires the user to provide the username and password associated with their master account.

To post a listing, a user or listing client utilizes the client device 102 to access the home page 140 (FIG. 2) and selects Post Listing 144, which displays the webpage for a listing form 204 shown in FIG. 7 to the user on the display 110 of the client device 102. Using the keyboard 112, the user enters listing data 200 into the fields 202 of the listing forms 204, which can include, but is not limited to a Listing Type, Category, Subcategory, Title, Target Price, Expiration Date, Completion Date, Zip Code, Max Distance, Approval Required, Credentials Required, Description, and information. In addition, files can be attached to the form 204. After entering the listing data 200, the user presses the “Submit” button 206 to electronically transfer the listing data 200 through the network 106 to the host server 104. The listing data 200 is recorded in a master account on the database 126.

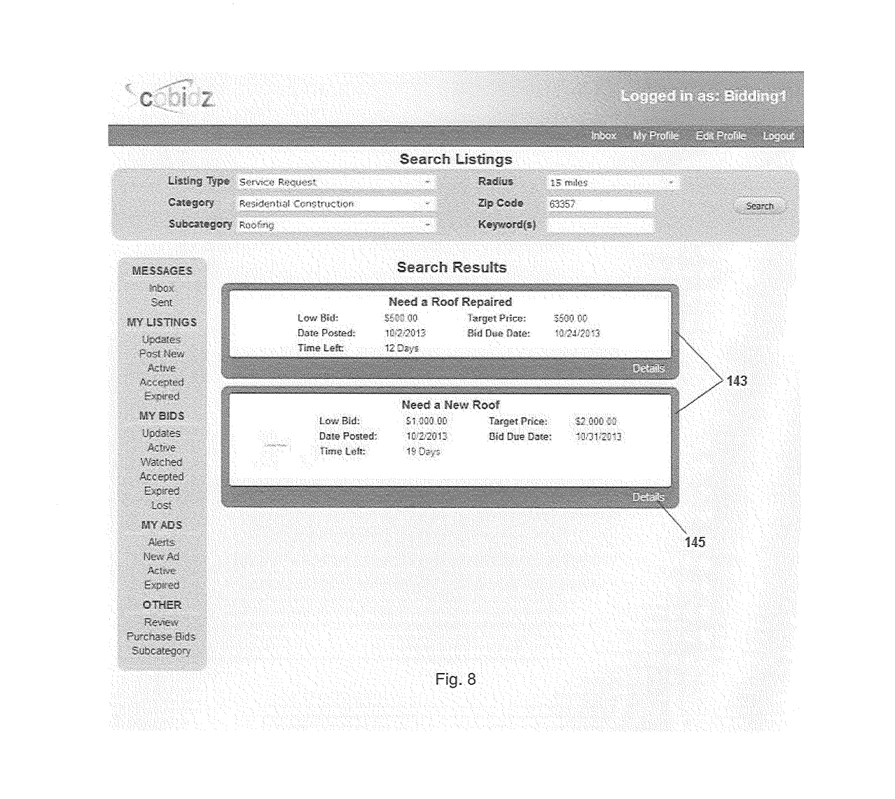

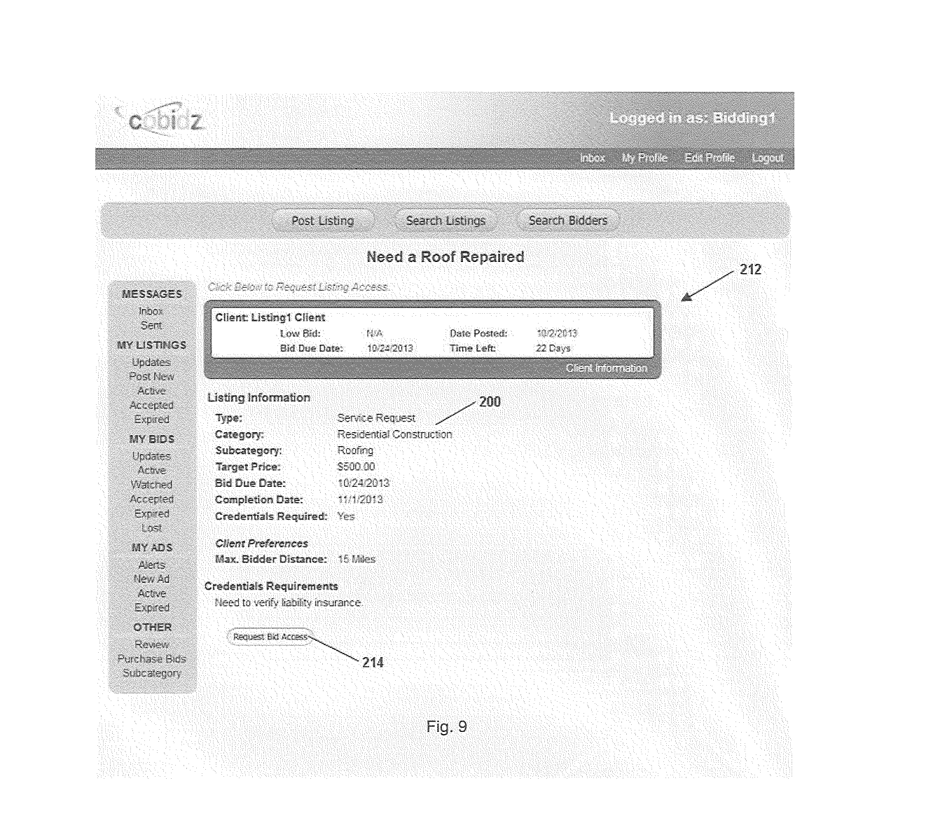

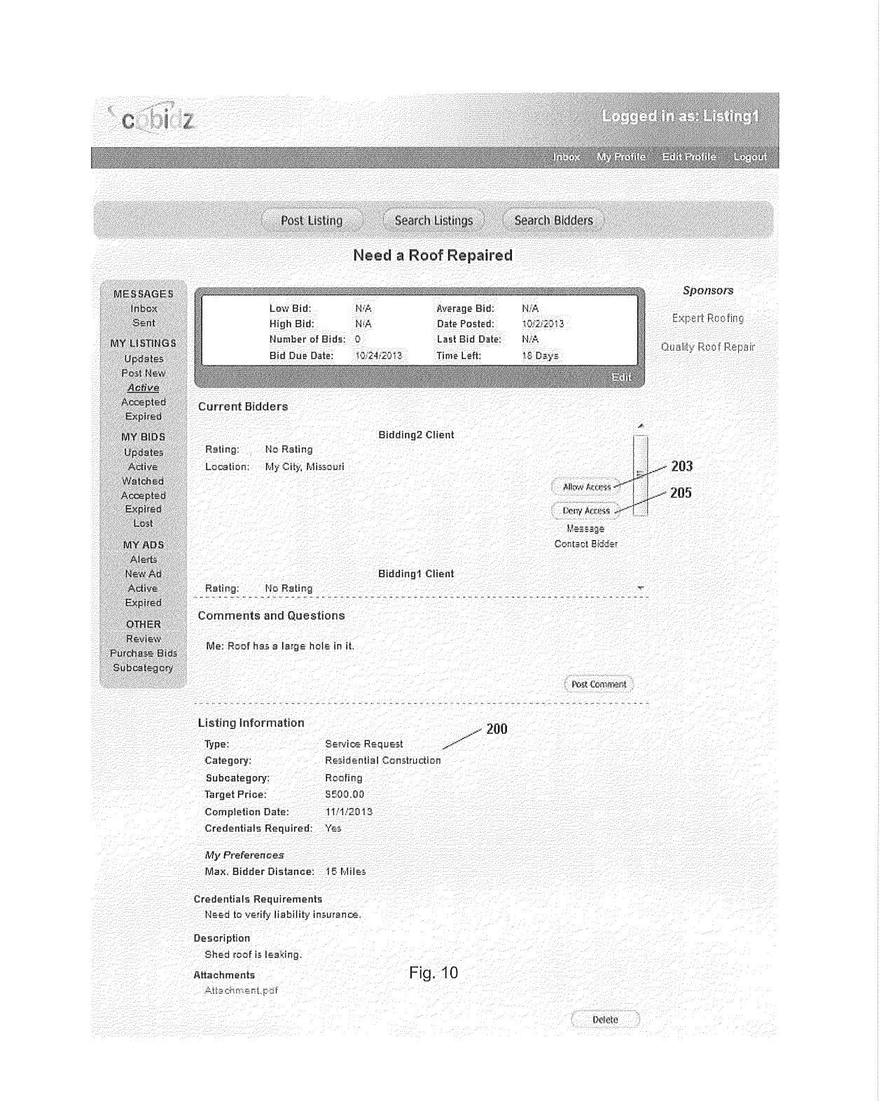

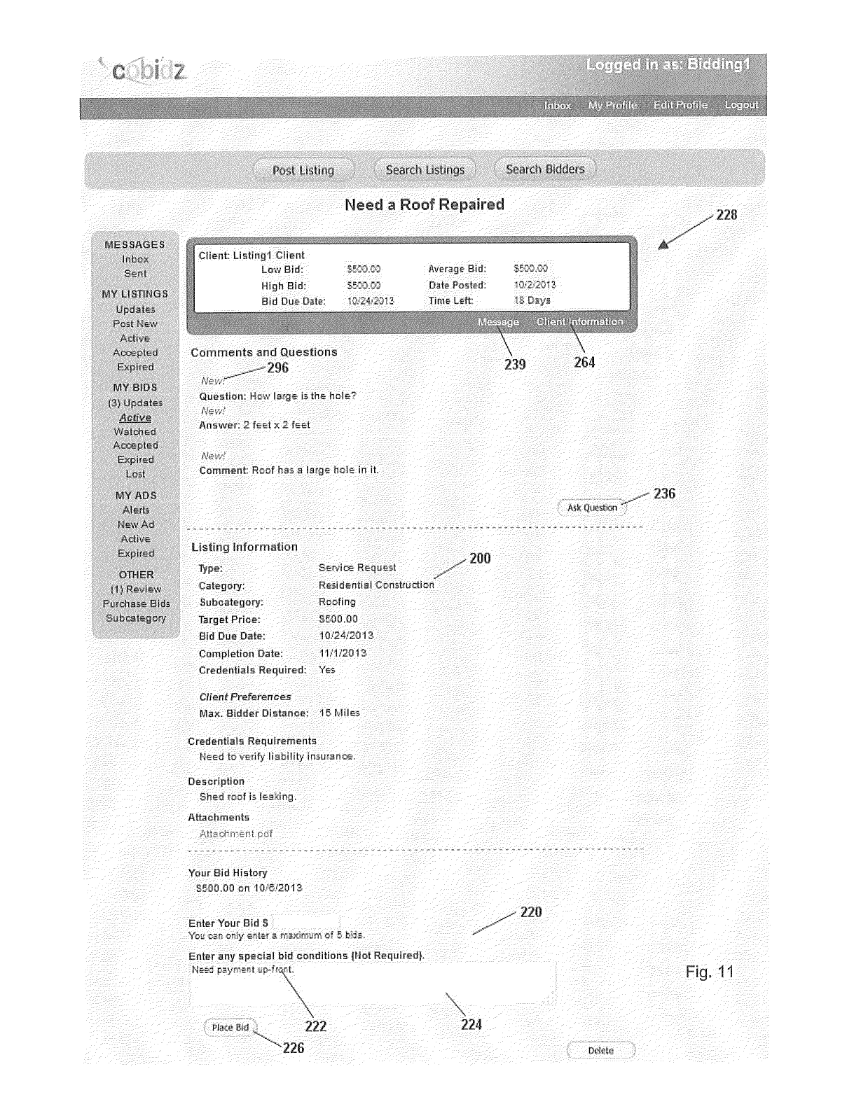

To find a listing, a user or bidding client utilizes the client device 102 to access the home page 140 (FIG. 2) and selects Search Listings 146. Based on the search criteria selected, the bid program 122 generates a collection of listings 143 (FIG. 8). By selecting the Details button 145 the bid program generates a listing webpage 212 (FIG. 9) or 228 (FIG. 11), depending on listing access settings, and interacts with the database 126 and the client device 102 for retrieval and display of listing data 200 to the user on the display 110 of the client device 102. If the listing client indicated the requirement for credentials, then the bid program 122 will only display a predetermined portion of the listing data 200 (FIG. 9). To obtain access to the full view of the listing data 200, the bidding client selects Request Bid Access 214 to alert the listing client of their intent to bid on the listing. Upon exchange and/or review of any required information the listing client selects whether to “Allow access” 203 or “Deny access” 205 to the full view of the listing data 200 (FIG. 10).

If the bidding client is allowed access to the listing data 200, the bid program 122 displays the listing data 200 to the bidding client on the display 110 of the client device 102 along with a bid entry form 220 (FIG. 11). Using the keyboard 112, the user enters bid data 222 into the fields 224 of the bid entry form 220, which can include, but is not limited to a Bid Amount, Special Bid Conditions, and other information. After entering the bid data 222, the user presses the “Place bid” button 226 to electronically transfer the bid data 222 through the network 106 to the host server 104. The bid data 222 is recorded in a master account on the database 126. Multiple bids can be placed by multiple bidding clients this way.

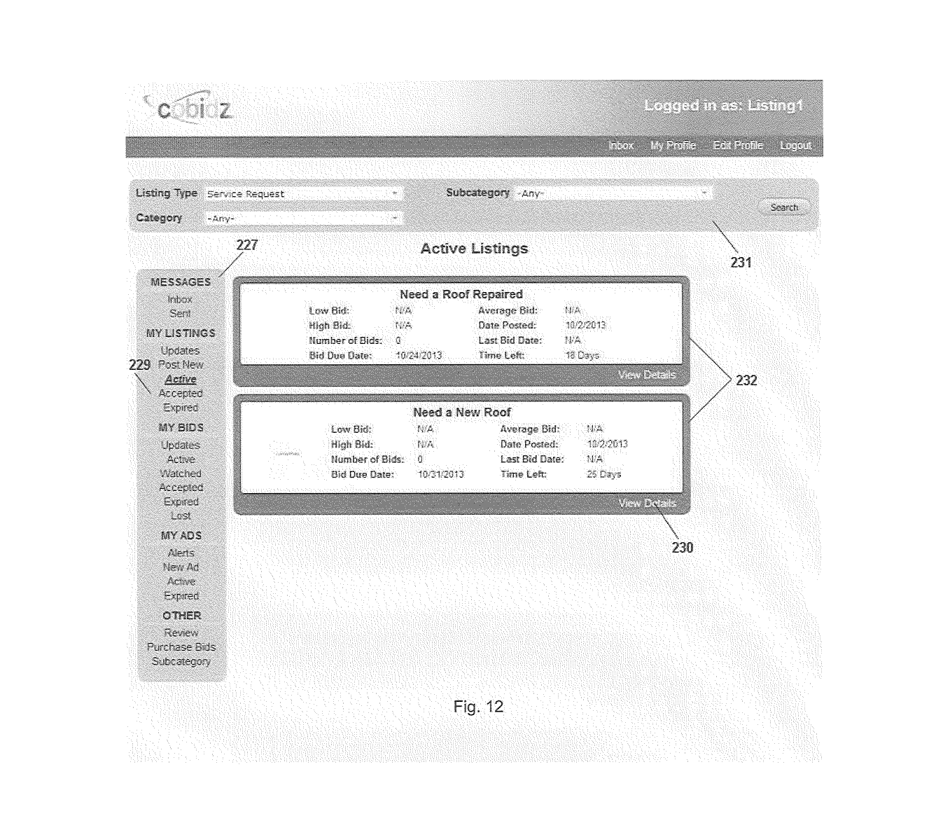

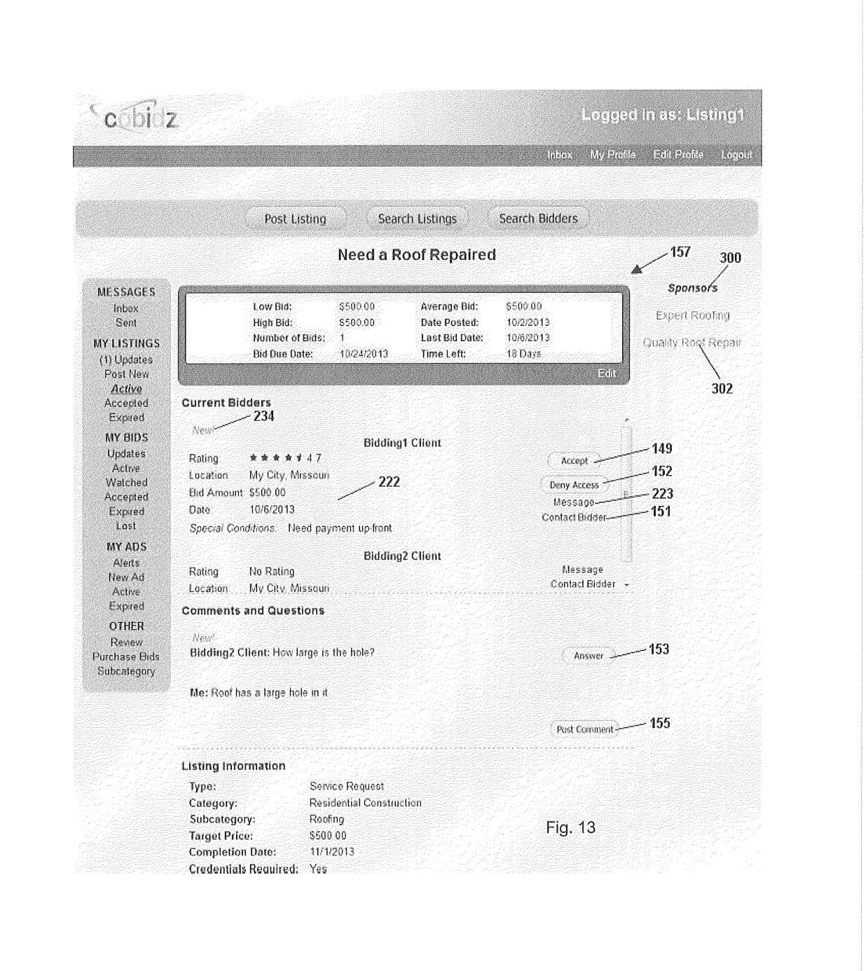

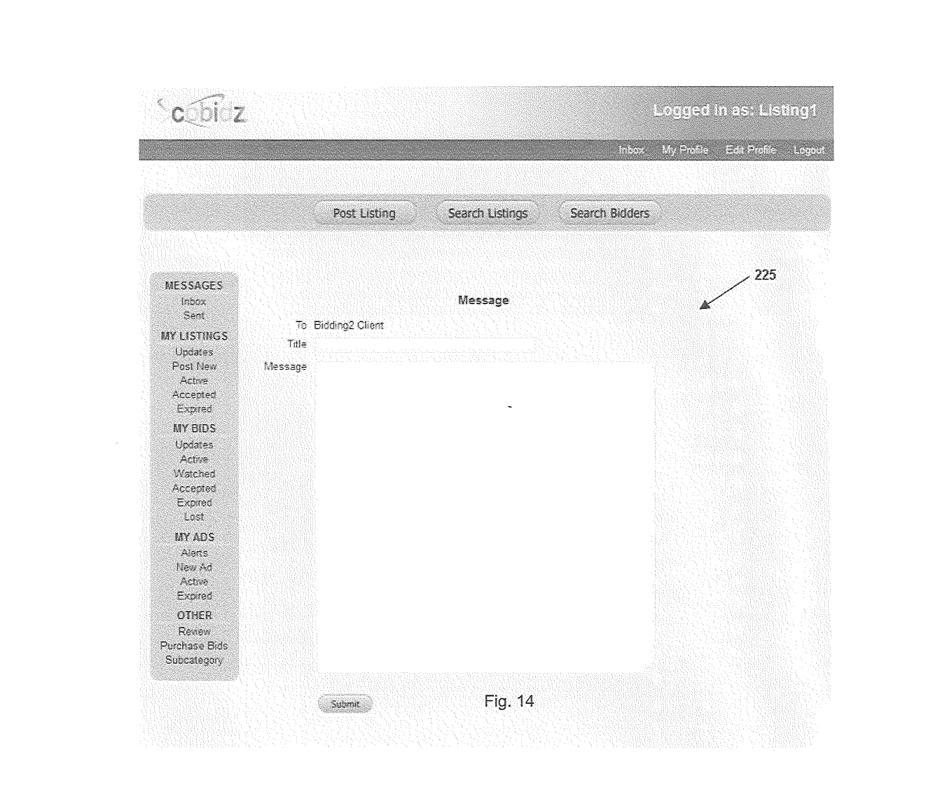

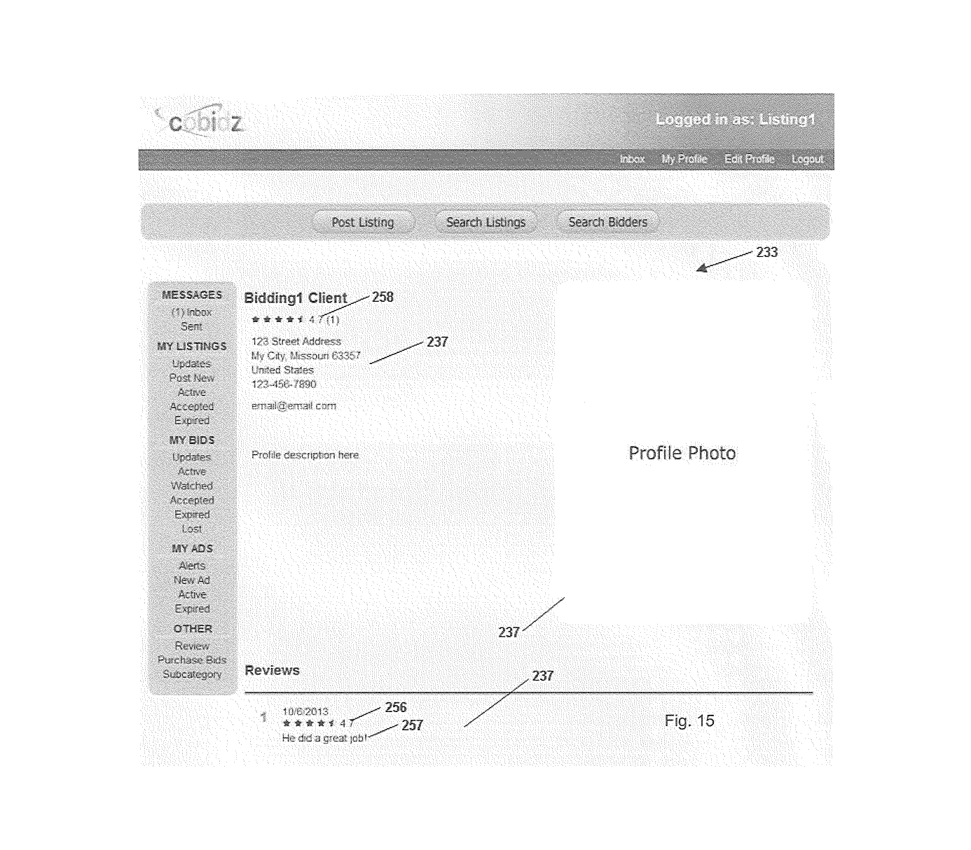

To view listing details like submitted bids, questions, etc., the listing client utilizes the client device 102 to access the auxiliary menu 227 (FIG. 12) and selects a button, such as, “Active”, “Accepted”, or “Expired” 229. The Selection Control 231 can then be used to select from the clients current listing types, categories, and subcategories into which listings were posted. Upon submitting the selection criteria the bid program 122 returns a list of the clients current listings 232 relevant to the selection on the display 110 of the client device 102 (FIG. 12). From the list of returned listings the listing client can select “View Details” 230 which displays the listing details page 157 with bid data 222 (FIG. 13) on a webpage to the listing client on the display 110 of the client device 102. The listing client can accept one of the bids by selecting “Accept” 149. In addition, the listing client may also deny access to a bidding client at any time by selecting Deny Access 152. Doing so removes this bidding client from the bidding pool and associated calculations which include, but is not limited to low bid, average bid, and high bid. If desired, the listing client may utilize the “Message” link 223 to communicate with the bidding client. By selecting the Message link 223 the bid program 122 generates a message webpage 225 (FIG. 14) on the display 110 of the client device 102. This communication is a component of the bid program 122 and communication data is stored in the database 126. The listing client can also use the “Contact Bidder” link 151 (FIG. 13) to display the bidding client's profile webpage 233 (FIG. 15) on the display 110 of the client device 102. The bidding client profile is comprised of information 237 which includes but is not limited to first name, last name, address, phone number, profile photo, and reviews.

In Addition, the listing client may use the “Answer” button 153 (FIG. 13) in conjunction with the keyboard 112 to reply to any questions a bidding client may have. These questions and answers are viewable by all bidding clients and stored in the database 126. To post a comment for all active bidding clients to view, the listing client may use the “Post Comment” button 155 in conjunction with the keyboard 112. All comments are stored in the database 126.

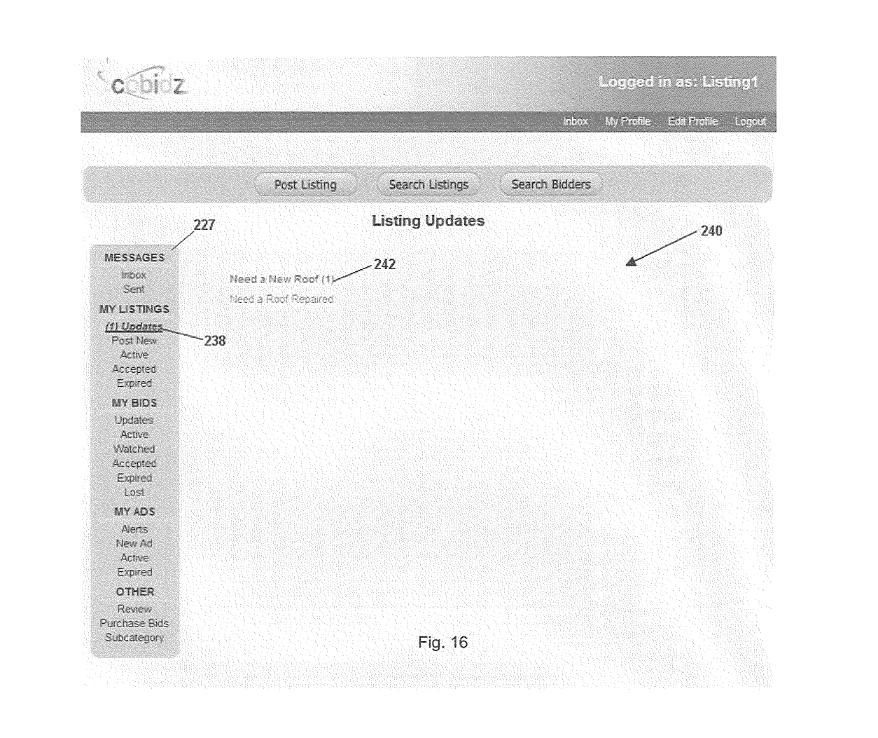

To view changes that have occurred with the users listings, the listing client utilizes the client device 102 and selects “Updates” 238 under the My Listings title in the auxiliary menu 227 (FIG. 16). Upon selecting Updates 238 the bid program 122 generates a webpage 240 which displays all of the client's listings that have had changes and the number of changes since the client last logged in, on the display 110 of the client device 102. The listing client may select any of the listing titles 242 to view the listing details webpage 157 (FIG. 13) on the display 110 of the client device 102. In the listing details webpage 157 any changes that occurred since the client last logged in are shown by the “New!” text 234 or some other descriptive alert.

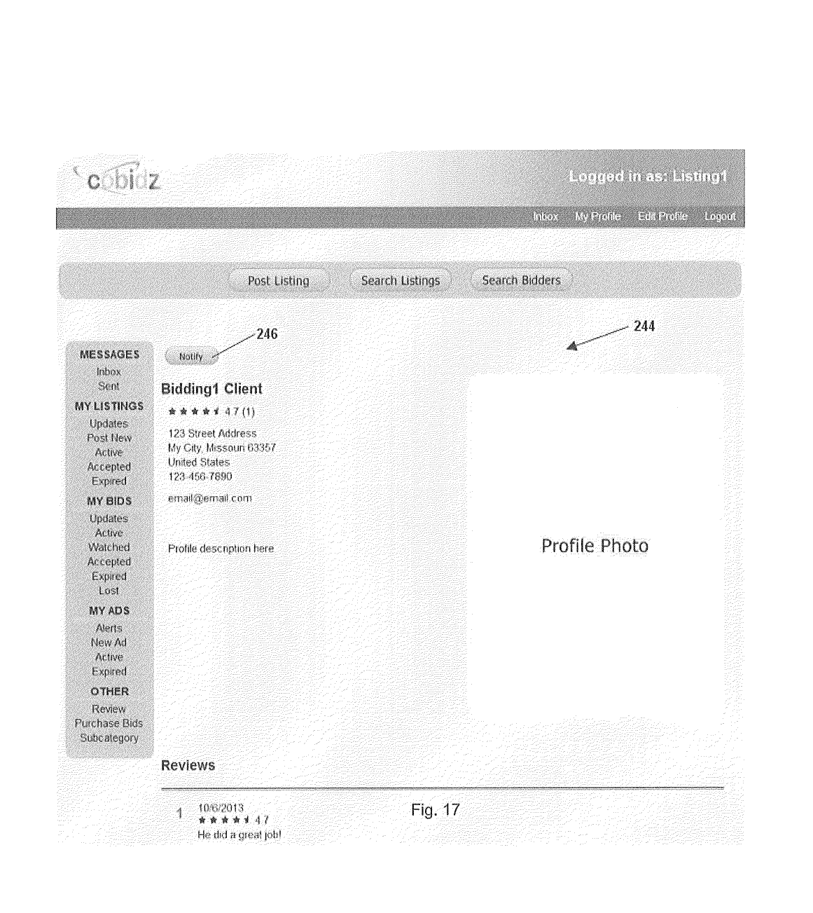

While the listing client is viewing the listing details page 157 on the display 110 of the client device 102, the second auxiliary menu 300, shown on the right side, may display sponsored links 302 that relate to, but is not limited to the listing type, category, and subcategory of the listing. The listing client may select any of the links 302 to view a potential bidding client's profile 244 (FIG. 17). If viewing the client's profile is generated from a sponsored link 302 the user may select the “Notify” button 246 to alert the bidding client of the listing client's listing.

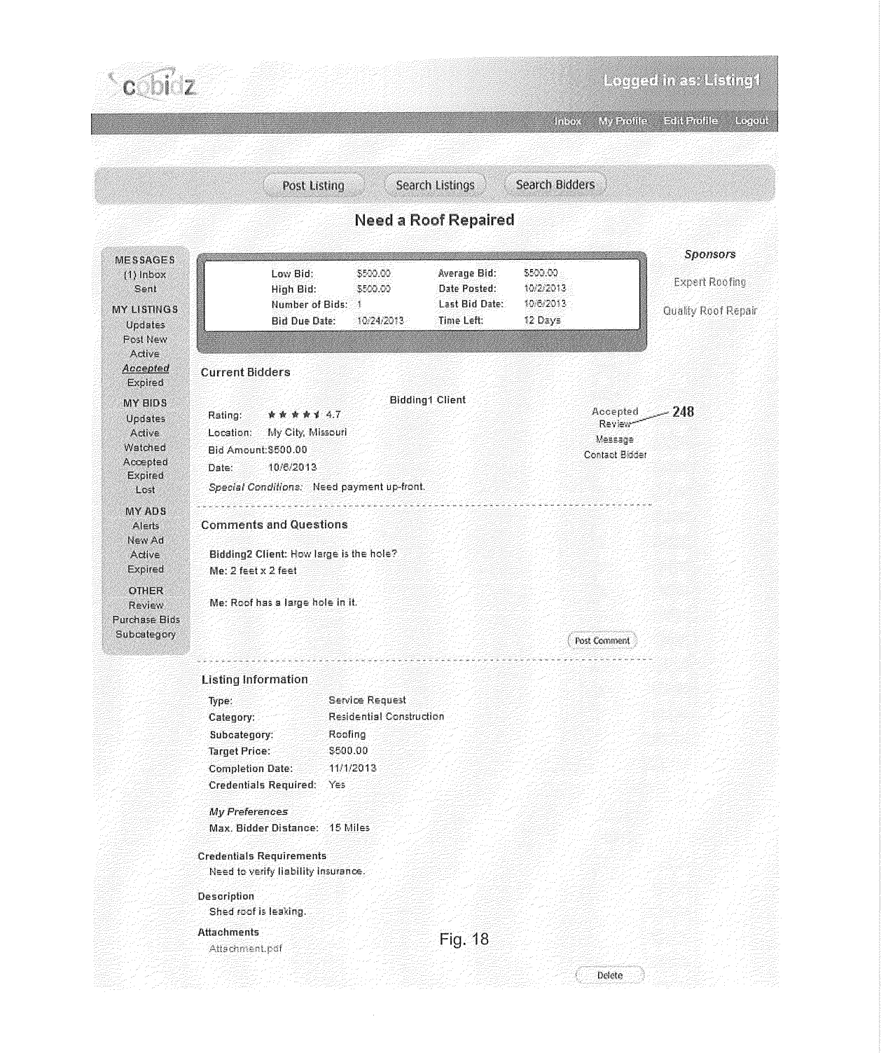

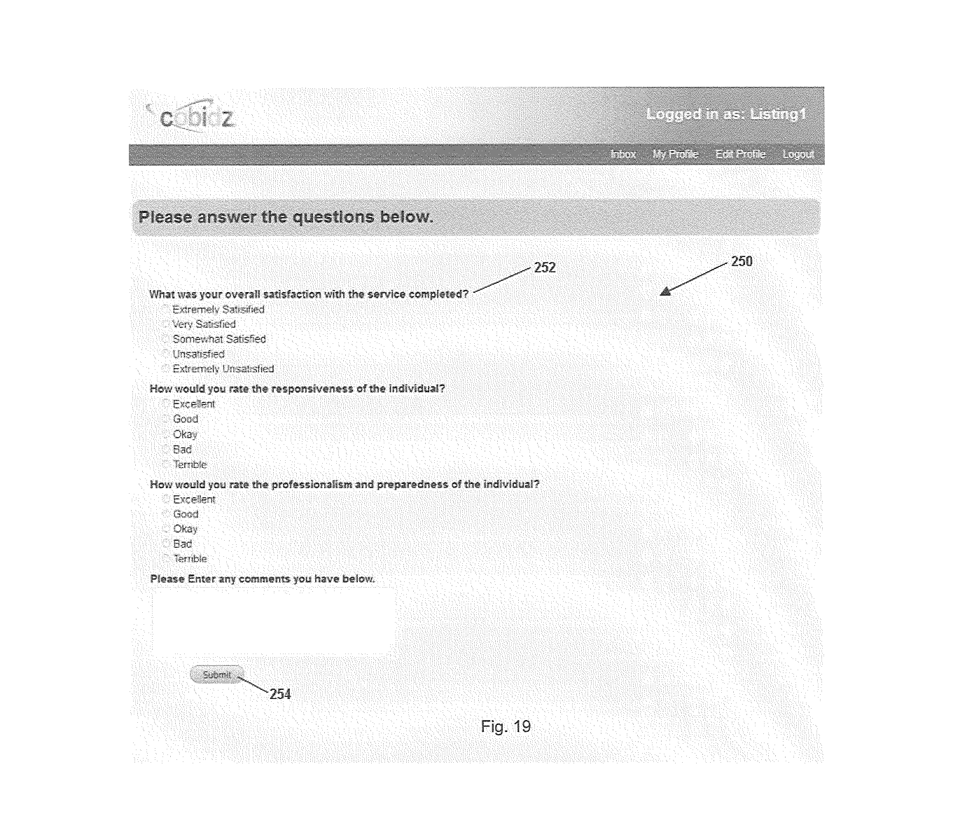

Once a listing client accepts a bid, the user is now able to review the bidding client. The process begins with the user utilizing the client device 102 and selecting the “Review” link 248 in the listing details page (FIG. 18). This action displays the review page 250 (FIG. 19) to the listing client on the display 110 of the client device 102. The client can now make selections to various questions 252 presented to them about the relationship with the bidding client. By selecting the Submit button 254, the bid program 122 calculates a review number 256 (FIG. 15) for the bidding client and stores it and any related comments 257 in the database 126. In addition, a new overall review number 258 is calculated for the bidding client and stored in the database 126.

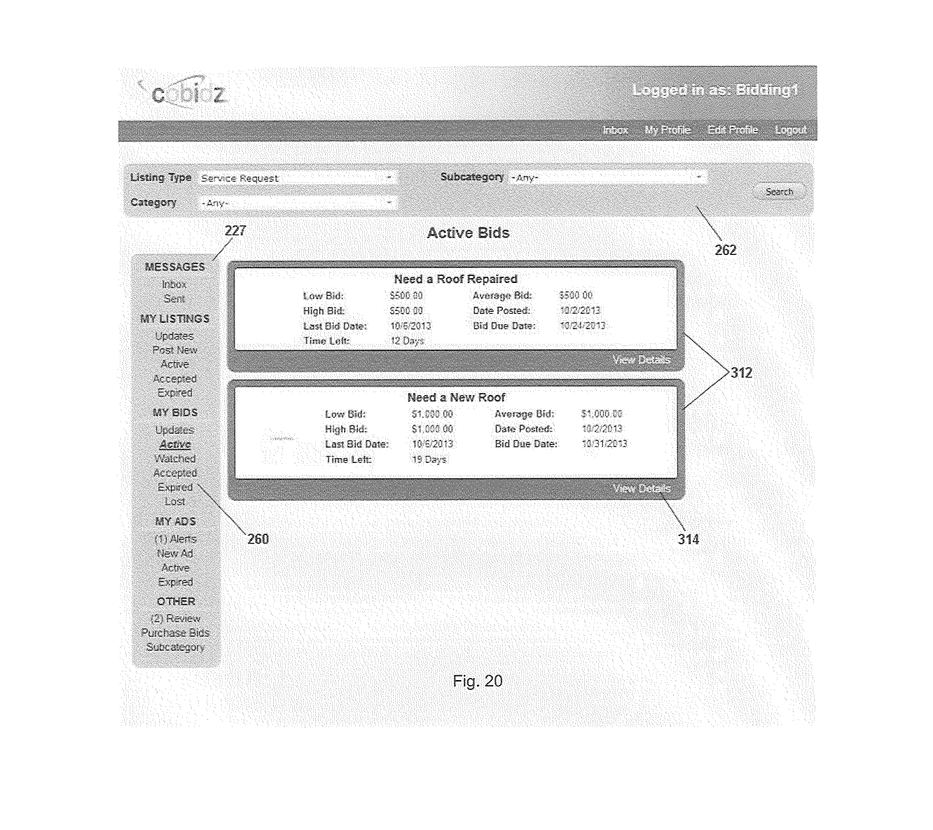

To view bid details like questions, answers, listing information, etc. the bidding client utilizes the client device 102 to access the first auxiliary menu 227 (FIG. 20), shown on the left, and selects the appropriate link, such as, “Active”, “Watched”, “Accepted”, “Expired”, or “Lost” 260 under the My Bids title. The Selection Control 262 can then be used to select from the clients current listing types, categories, and subcategories for which the user placed bids. Upon submitting the selection criteria the server 104 communicates a set of listings 312 that were bid on relevant to the selection. From the list of returned listings the bidding client can select “View Details” 314 which displays the listing data on a webpage as shown in FIG. 11 to the bidding client on the display 110 of the client device 102. The bidding client may ask a question by using the “Ask Question” button 236 (FIG. 11) in conjunction with the keyboard 112. Questions are posted to the listing and bid details pages (FIGS. 13 and 11 respectively) for all associated users to view under the Comments and Questions section. All questions are stored in the database 126.

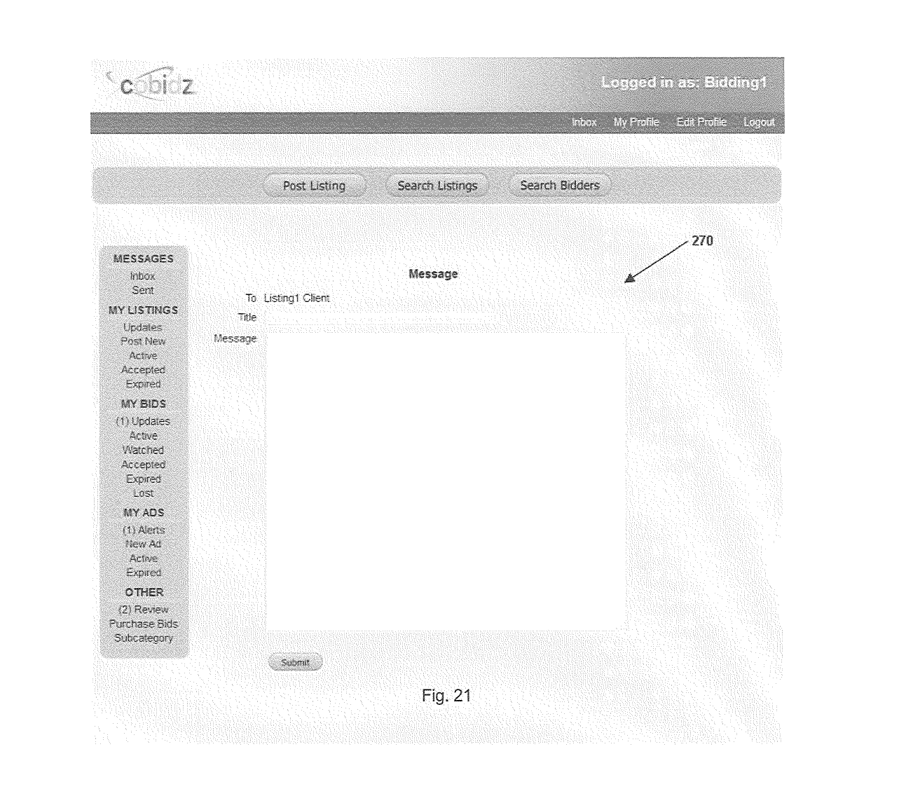

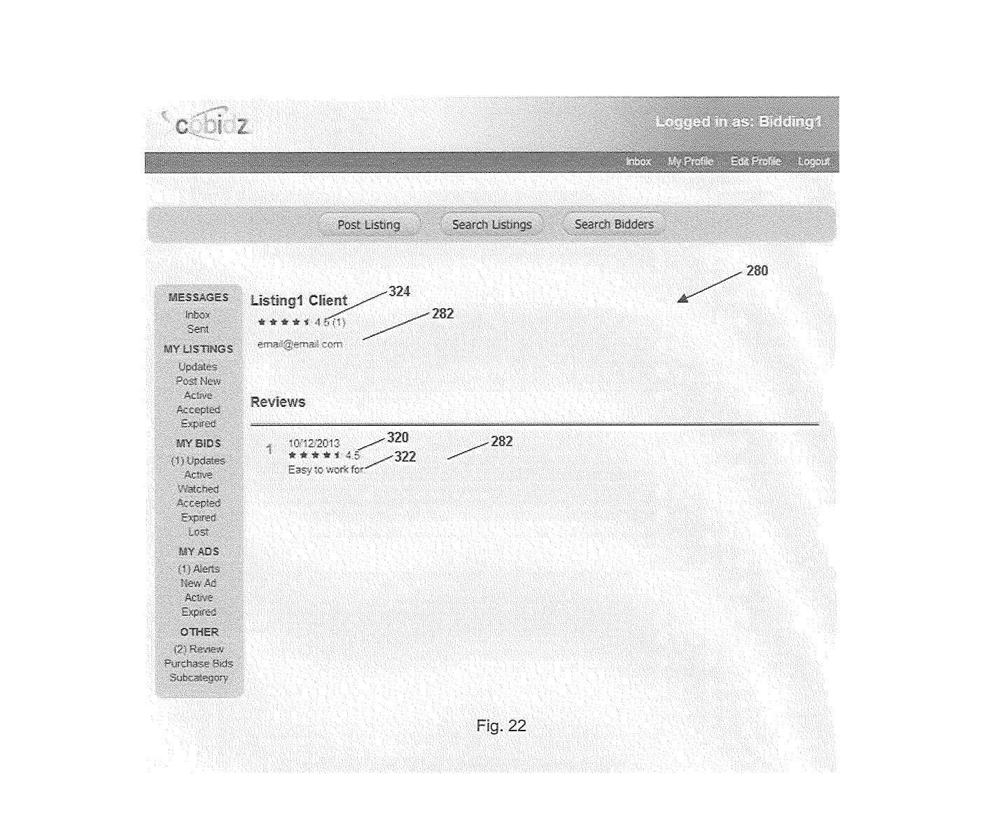

In addition, the bidding client may utilize the client device 102 and select the “Message” link 239 (FIG. 11) to communicate with the listing client. By selecting the Message link 239 the bid program 122 generates a message webpage 270 (FIG. 21) on the display 110 of the client device 102. This communication is a component of the bid program 122 and communication data is stored in the database 126. Also the bidding client can use the “Client Information” link 264 (FIG. 11) to display the listing client's profile webpage 280 (FIG. 22) on the display 110 of the client device 102. The listing client profile is comprised of information 282 which can include but is not limited to username, first name, last name, address, phone number, profile photo, and reviews. If the Listing client chose to conceal any of the information 282 in the registration pages 154, the bidding client will be able to view, on the display 110 of the client device 102, only what was allowed by the listing client.

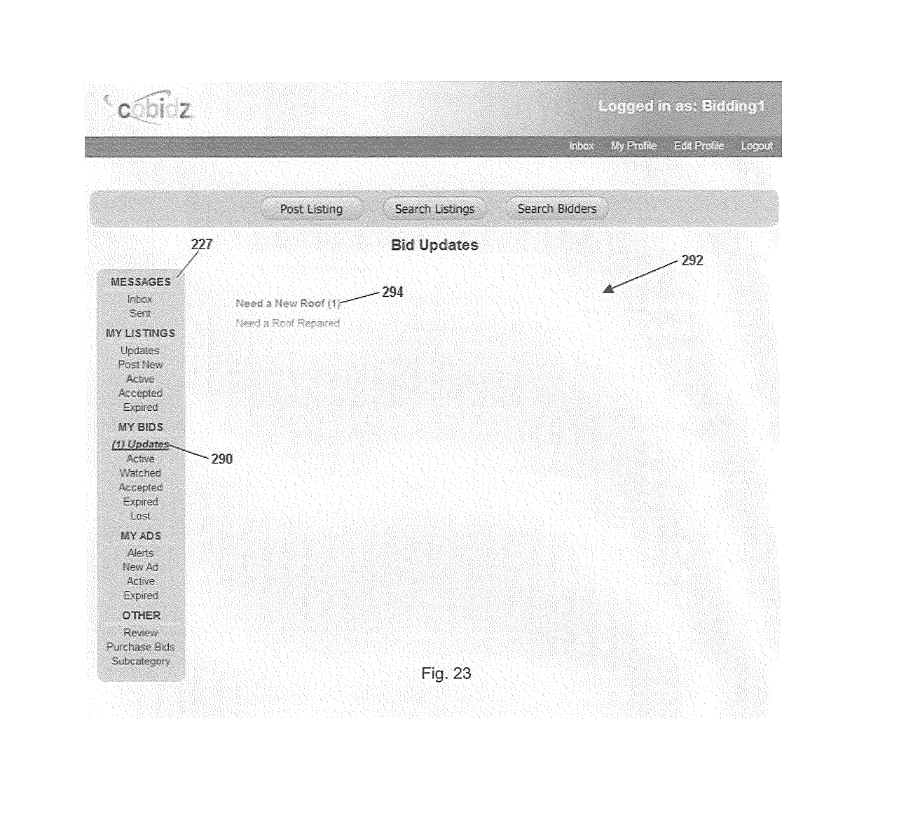

To view changes that have occurred with the listings the user has bid on, the bidding client utilizes the client device 102 and selects “Updates” 290 under the My Bids title in the auxiliary menu 227 (FIG. 23). Upon selecting Updates 290 the bid program 122 generates a webpage 292 which displays all of the client's bid-on listings that have had changes and the number of changes since the client last logged in, on the display 110 of the client device 102. The bidding client may select any of the listing titles 294 to view the bid details webpage 228 (FIG. 11) on the display 110 of the client device 102. In the bid details webpage 228 any changes that occurred since the client last logged in are shown by the “New!” text 296 or some other descriptive alert.

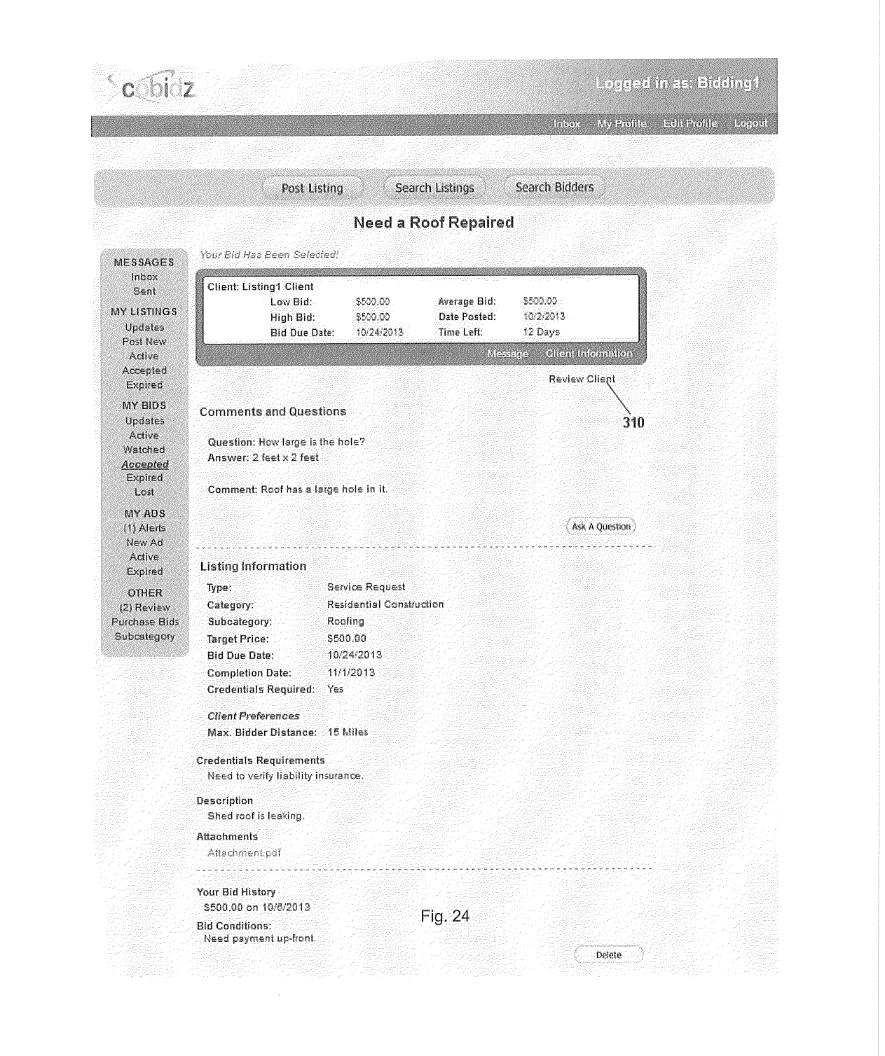

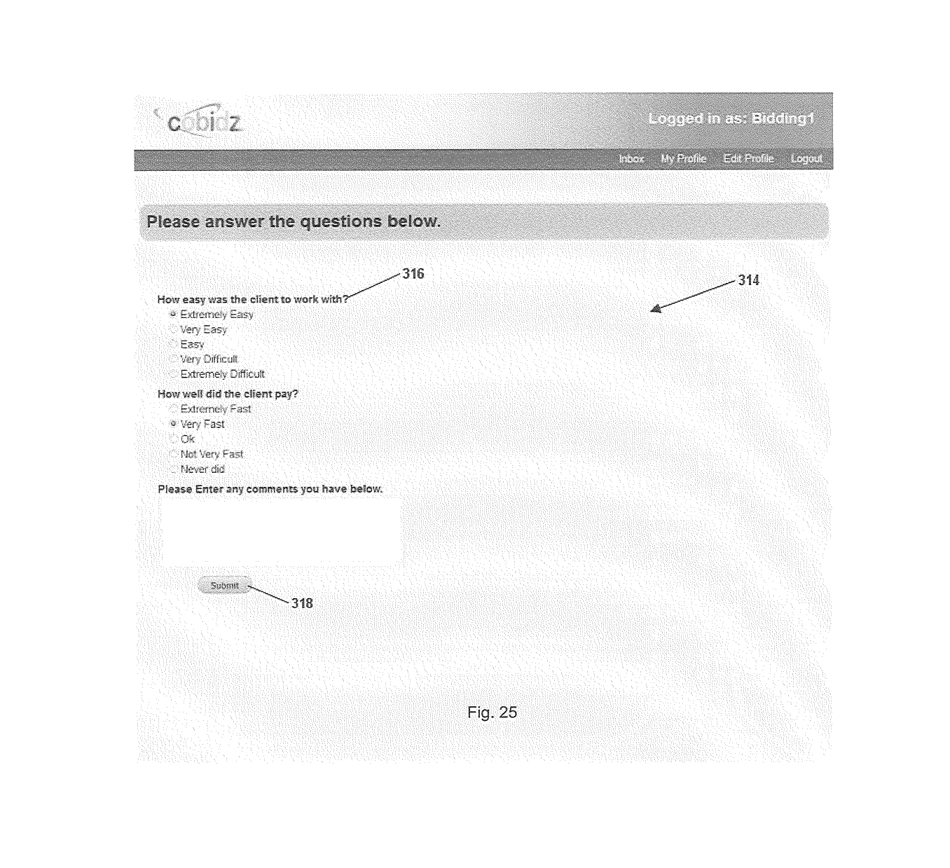

Once a listing client accepts a bid, the accepted bidding client is now able to review the listing client. The process begins with the bidding client utilizing the client device 102 and selecting the “Review Client” link 310 in the bid details page (FIG. 24). This action displays the review page 314 (FIG. 25) to the bidding client on the display 110 of the client device 102. The bidding client can now make selections to various questions 316 presented to them about the relationship with the listing client. By selecting the Submit button 318, the bid program 122 calculates a review number 320 (FIG. 22) for the listing client and stores it and any related comments 322 in the database 126. In addition, a new overall review number 324 is calculated for the listing client and stored in the database 126.

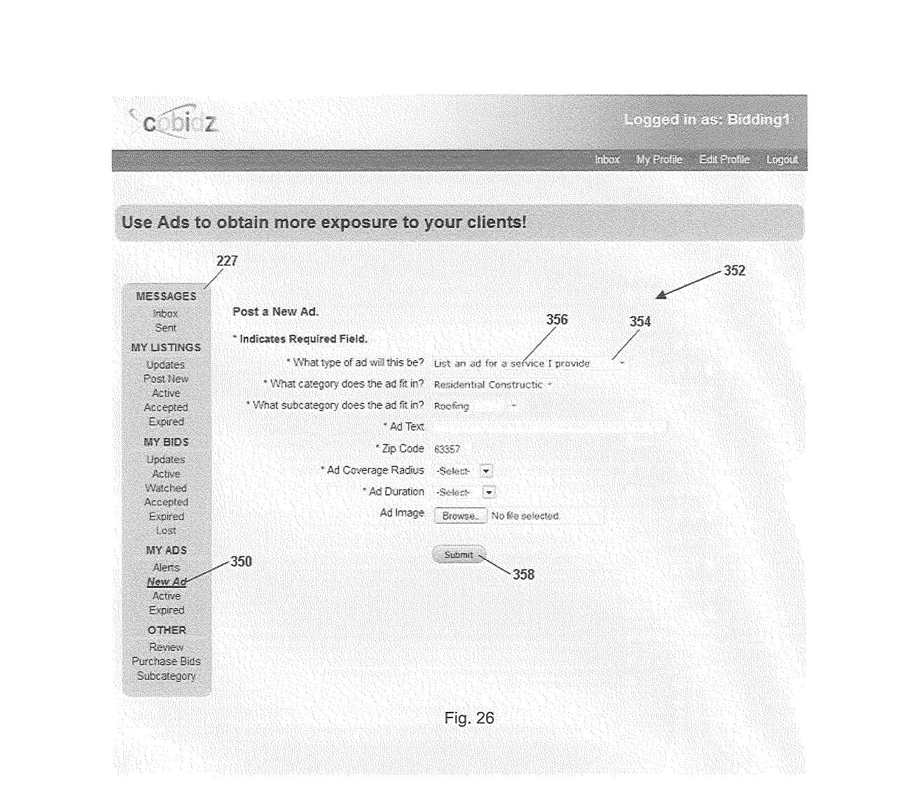

To post an advertisement, a user utilizes the client device 102 to access the first auxiliary menu 227 and selects “New Ad” 350, which displays the webpage for an advertisement form 352 (FIG. 26) to the user on the display 110 of the client device 102. Using the keyboard 112, the user enters advertisement data 356 into the fields 354 of the advertisement form, which can include, but is not limited to an Ad type, Category, Subcategory, Ad Text, Zip Code, Ad Coverage Radius, and Ad Duration. In addition, files can be attached to the form. After entering the advertisement data, the user presses the “Submit” button 358 to electronically transfer the advertisement data through the network 106 to the host server 104. The advertisement data 356 is recorded in a master account on the database 126.

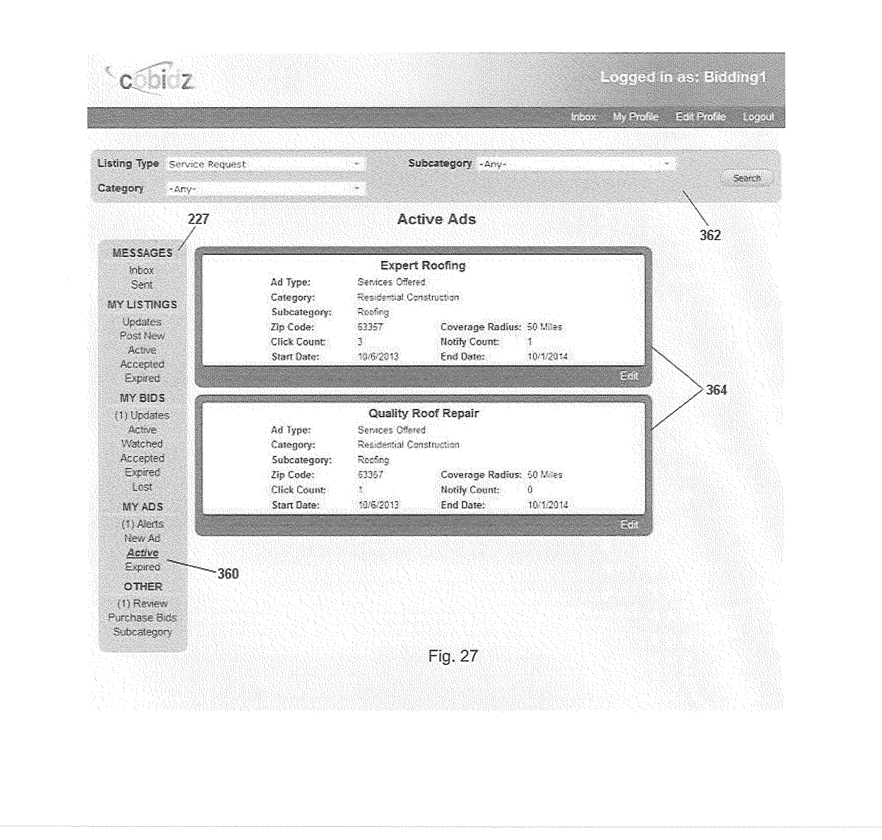

To view advertisement details like Start Date, End Date, Click Count, etc. the user utilizes the client device 102 to access the first auxiliary menu 227 (FIG. 27), shown on the left, and selects “Active”, or “Expired” 360 under the My Ads title. The Selection Control 362 can then be used to select from the clients current advertisement types, categories, and subcategories for which the user placed advertisements. Upon submitting the selection criteria the server 104 communicates a collection of advertisements 364 that were posted to the host server 104, relevant to the selection.

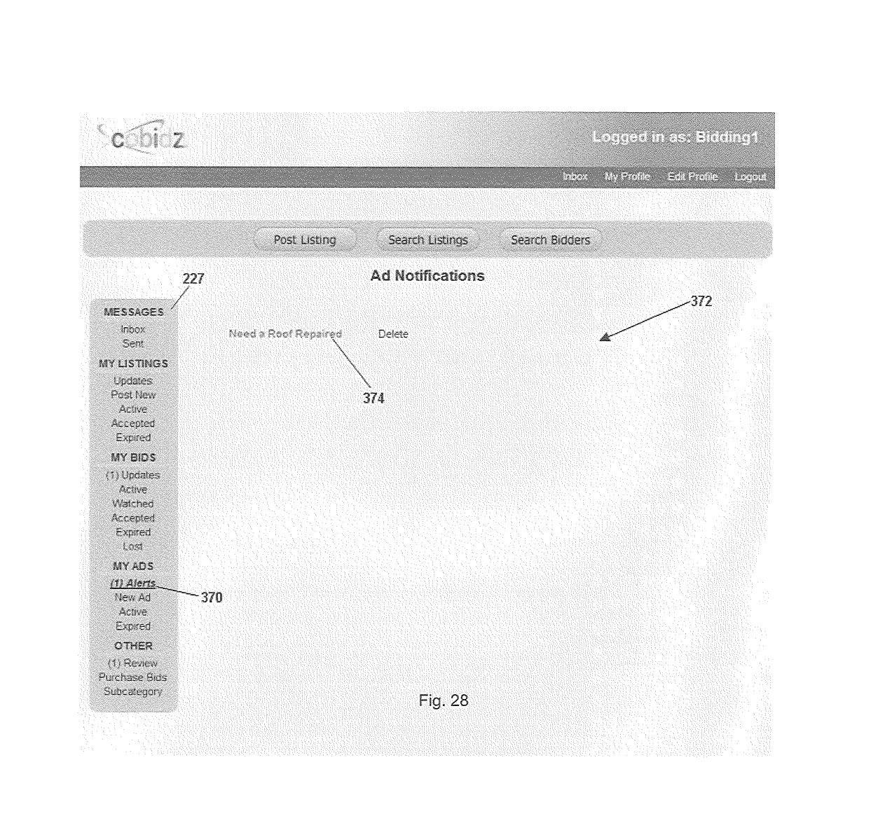

To view notifications from advertisements the client utilizes the client device 102 and selects “Alerts” 370 (FIG. 28), under the My Ads title in the first auxiliary menu 227. Upon selecting Alerts 370 the bid program 122 generates a webpage 372 which displays all of the notifications received from clients, through the advertisement menu 300 (FIG. 13), on the display 110 of the client device 102. The user may select any of the listing titles 374 (FIG. 28) to view potential bidding opportunities through the bid details webpage 228 (FIG. 11) on the display 110 of the client device 102.

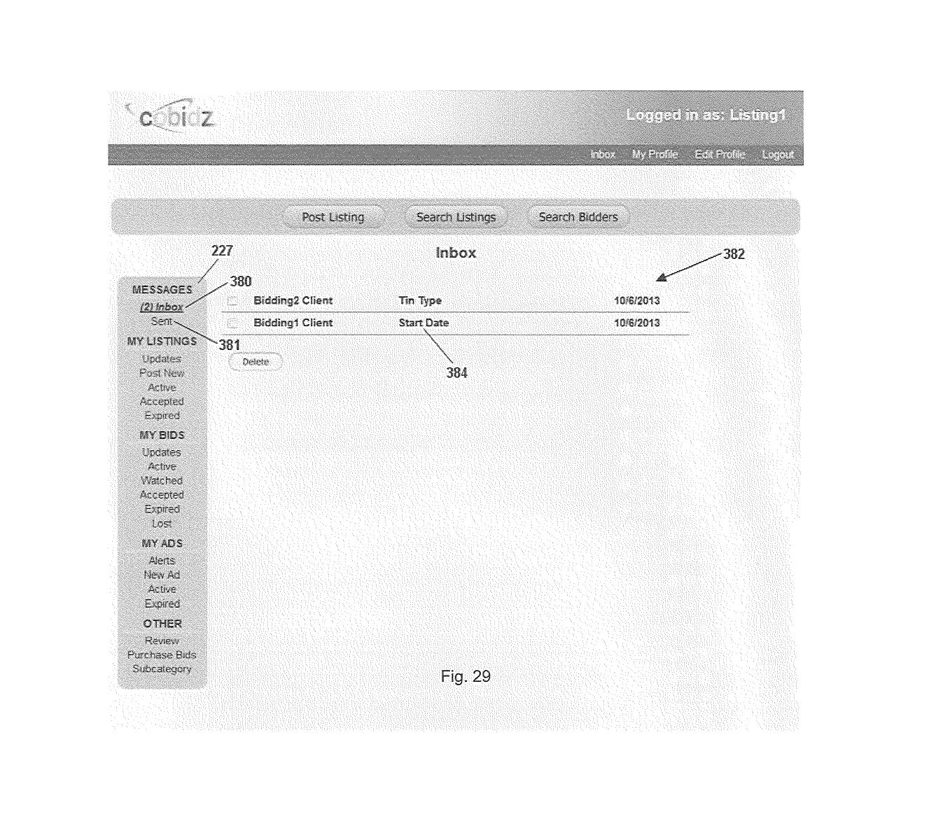

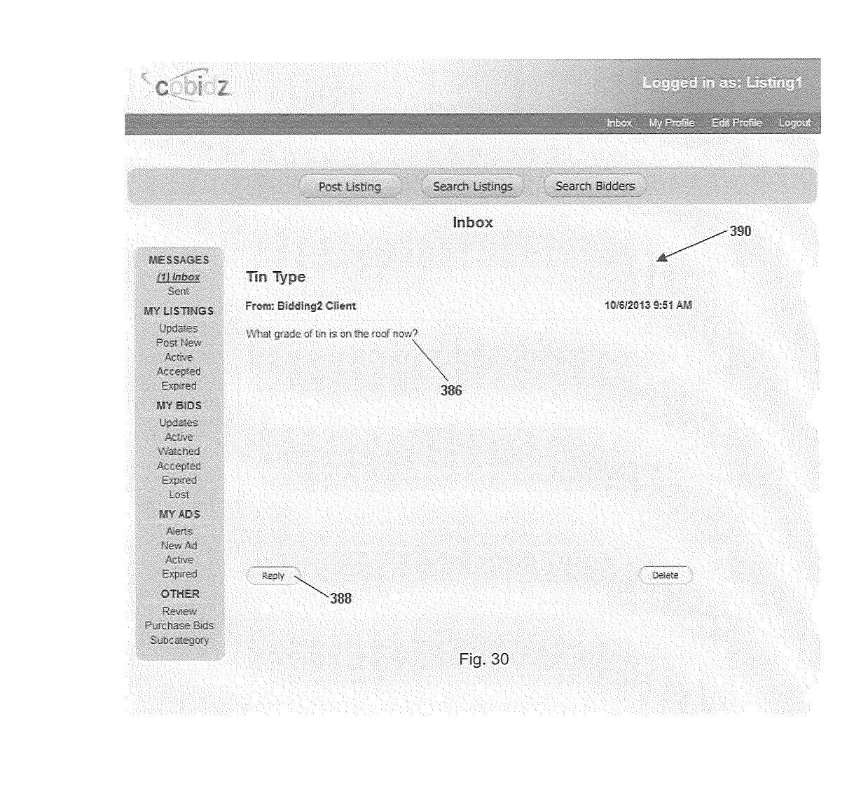

For clients to view messages that other users may have sent to them the client utilizes the client device 102 and selects “Inbox” 380 (FIG. 29) in the first auxiliary menu 227. Upon selecting Inbox 380 the bid program 122 generates the inbox page 382, displaying a list of messages that have been sent to the client, on the display 110 of the client device 102. The user may select a message 384 from the list to view specific message data 386 (FIG. 30) in the webpage 390 on the display 110 of the client device 102. Also the user may reply to the message by selecting the “Reply” button 388 on the webpage 390. All message data is stored in the database 126. Any sent messages may be viewed by selecting “Sent” 381 (FIG. 29) in the first auxiliary menu 227. Upon selecting Sent 381 the bid program 122 generates a list of messages sent by the client on the display 110 of the client device 102.

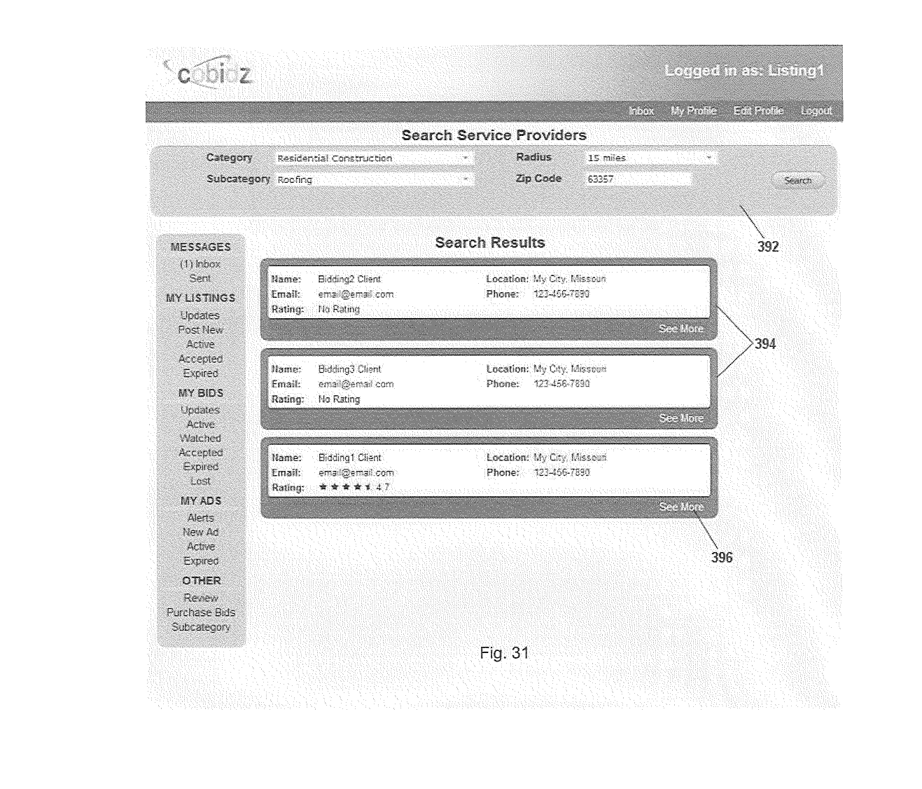

To find a bidder, a user utilizes the client device 102 to access the home page 140 and selects Search Bidders 148. Based on the search criteria selected in the selection menu 392 (FIG. 31), which can include but is not limited to Category, Subcategory, Search Radius and Zip code, the bid program 122 generates a collection of bidders 394 (FIG. 31). By selecting “See More” 396 the bid program 122 displays a bidding client profile page 233 (FIG. 15) on the display 110 of the client device 102.

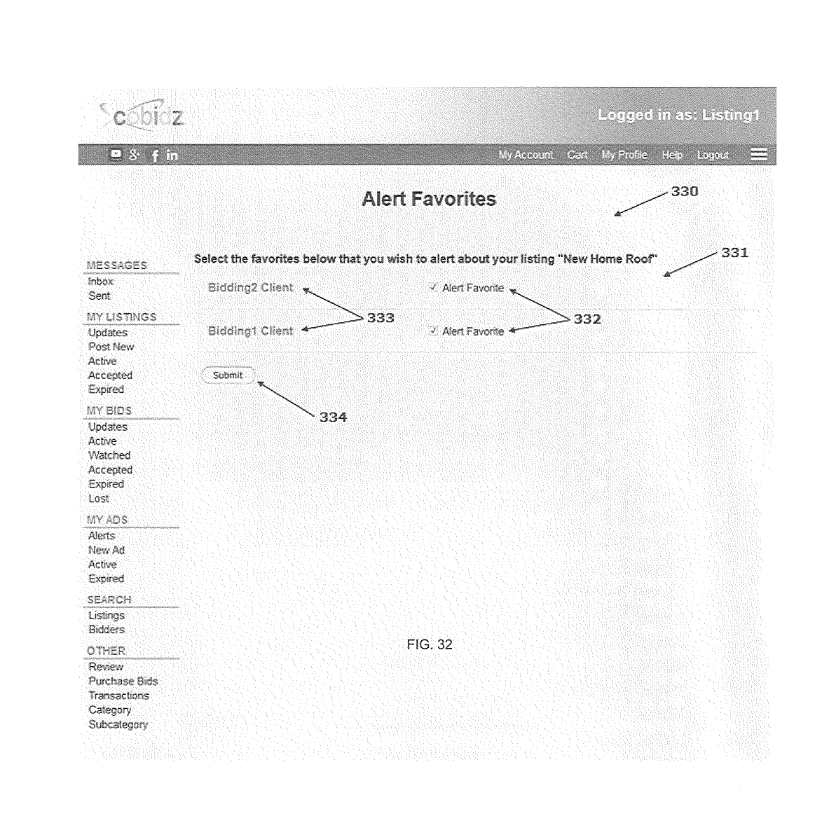

In addition, a listing client may alert favorite bidding clients about posted listings. Utilizing the client device 102, display 110, and keyboard 112, the user selects the “Submit” button 206 FIG. 7, which electronically retrieves a list 331 FIG. 32 of favorite clients from the database 126 through the network 106 and displays the “Alert Favorite's” webpage 330 to the user on the display 110 (FIG. 32). The listing client may choose to alert specific bidding clients by selecting them individually using fields 332. Upon making the desired selections, the user selects the “Submit” button 334 to transmit the selected bidding clients 333 to the host server 104 across the network 106. The host sever 104 operates the bid program 122 and accesses the database 126 to determine if the selected bidding clients 333 have chosen to receive alerts. The host server 104 then operates the bid program 122 to send an electronic message to each selected bidding client 333 that has chosen to receive alerts, across the network 106.

Changes can be made in the above constructions without departing from the scope of the invention, it is intended that all matter contained in the above description or shown in the accompanying drawings shall be interpreted as illustrative and not in a limiting sense. For example, the bid program 122 can display paid advertisements or sponsors on the various webpages.

What is claimed is:

1. A method of administering a bid, through a computer system having at least one server, at least one client device, and a communication network operatively and electrically connecting the client device to at least one server, the method comprising the steps of:
accessing, by a first user from the client device, a website running on at least one server, and entering data into the at least one client device by the first user;
accessing, by a second user from the client device, a website running on at least one server, and entering data into the at least one client device by the second user;
transmitting the data to at least one server;
generating, with a first program on the at least one server, results associated with the data and displaying the results associated with the data on at least one client device;
communicating bidding information between the first user and the second user through a bidding program.

2. The method of administering a bid of claim 1, further comprising the steps of:
generating, with the first program on the at least one server, results associated with listing data;
requesting access, by a second user from the client device, access to the results of the listing data;
granting access to the listing data, by the first user from the client device; and
displaying the results associated with the listing data on at least one client device.

3. The method of administering a bid of claim 1,
entering bid data, by the second user into the client device,
transmitting the bid data to at least one server; and
accepting a bid, by the first user from the client device.

4. The method of administering a bid of claim 1, further comprising the steps of:
entering registration data applicable to a first user into the client device; and
transmitting the registration data to at least one server;
storing the registration data in at least one server.

5. The method of administering a bid of claim 1, further comprising the steps of:
entering advertisement data applicable to a first user into the client device; and
transmitting the advertisement data to at least one server;
storing the advertisement data in at least one server.
displaying the advertisement data associated with the listing data on at least one client device.

6. The method of administering a bid of claim 1, sending electronic messages between the client devices to concerning the bid data.

7. A computer system for administering a bidding process, comprising:
at least one server;
at least one client device;
and a communication network operatively and electrically connecting the client device to at least one server;

8. The computer system for administering a bidding process of claim 7, further comprising:
a first program on the at least one server for generating results associated with the listing data;
wherein a second user requests access to the results of the listing data from the client device;
wherein the first user grants access to the listing data, from the client device; and
wherein the results associated with the listing data display on at least one client device.

9. The computer system for administering a bidding process of claim 7, further comprising:
bid data entered by the second user into the client device,
wherein the bid data transmits to at least one server; and
wherein the first user accepts a bid from the client device.

10. The computer system for administering a bidding process of claim 7, further comprising:
registration data applicable to a first user entered into the client device; and
wherein the registration data transmits to at least one server;
wherein the registration data is stored in at least one server.

11. The computer system for administering a bidding process of claim 7, further comprising:
advertisement data applicable to a first user entered into the client device; and
wherein the advertisement data transmits to at least one server;
wherein advertisement data is stored in at least one server.
wherein the advertisement data associated with the listing data is displayed on at least one client device.

12. The computer system for administering a bidding process of claim 7, further comprising sending electronic messages between the client devices concerning the bid data.
